(19) United States
(12) Patent Application Publication
(10) Pub. No.: US 2012/0174034 A1
(43) Pub. Date: Jul. 5, 2012

(54) METHOD AND APPARATUS FOR PROVIDING USER INTERFACE IN USER EQUIPMENT

(76) Inventors: Haeng-Suk CHAE, Gyeonggi-do (KR); Kyoung-Tae CHOI, Gyeonggi-do (KR)

(21) Appl. No.: 13/342,396

(22) Filed: Jan. 3, 2012

(30) Foreign Application Priority Data
Jan. 3, 2011 (KR) 10-2011-0000076

(51) Int. Cl. G06F 3/048

(52) U.S. Cl. 715/835

(57) ABSTRACT

Apparatus and/or method for providing a user interface in a user equipment. At least one background screen of the user interface may be formed from at least one image. Each of the at least one background screen may be associated with a respective application of the user equipment, and each image of the at least one image may represent a respective content associated with the respective application. Then, when a user input at least one of a predetermined gesture input and a predetermined key input, a main menu which allows the user to select a desired application to be executed may be displayed over a current display screen. When a selection input for selecting the desired application is received from the displayed main menu, the user interface having the background screen formed from the at least one image corresponding to the selected desired application may be displayed.

### CROSS REFERENCE TO PRIOR APPLICATIONS

The present application claims priority under 35 U.S.C. §119 to Korean Patent Application No. 10-2011-0000076 (filed on Jan. 3, 2011), which is hereby incorporated by reference in its entirety.

### FIELD OF THE INVENTION

Apparatuses and methods consistent with the present invention relate to providing a user interface, and more particularly, to providing a user interface for integrated access to various content associated with applications and/or functions of a user equipment.

### BACKGROUND OF THE INVENTION

Some kinds of user equipment (e.g. cellular telephones) were originally developed for telephone communications. Over time, types of user equipment have advanced to devices having high processing power and can perform various functions besides telephone communications. This advancement of user equipment enables a user to do many tasks as well as telephone communication. For example, a user can play back various types of multimedia data (e.g. MP3 play back). A user can browse web-sites while communicating with other parties. A user can watch a movie while sending a text message to other parties. Due to such convenience, the demand for user equipment has been rapidly increased.

Although user equipment may have high processing power and various functions, many users still use their user equipment only for telephone communication. In many cases, this underutilization of the full capabilities of user equipment is because the user equipment may have a difficult-to-use or inconvenient user interface. For example, in order to use a certain function of a user equipment, a user must go through several steps for selecting the certain function from a tree structured options menu. Accordingly, there is a demand for a user interface that allows a user to conveniently use various functions of a user equipment.

### SUMMARY OF THE INVENTION

Embodiments of the present invention overcome the above disadvantages and other disadvantages not described above. Also, the present invention is not required to overcome the disadvantages described above, and an embodiment of the present invention may not overcome any of the problems described above.

Embodiments relate to a method and/or apparatus for providing a user interface in a user equipment that may improve user convenience.

In accordance with embodiments, at least one background screen of a user interface may be formed from at least one image. Each of the at least one background screens may be associated with a respective application of the user equipment, and each image of the at least one image may represent a respective content associated with the respective application. When a user inputs at least one of a predetermined gesture input and a predetermined key input, a main menu which allows the user to select a desired application to be executed may be displayed over a current display screen. When a selection input for selecting the desired application is received from the displayed main menu, the user interface having the background screen formed from the at least one image corresponding to the selected desired application may be displayed.

After displaying the user interface having the background screen, in accordance with embodiments, updated content associated with a respective application may be received, and the displayed user interface having the background screen may be updated with the received updated content at an update interval of time. In accordance with embodiments, an apparatus may provide a user interface in a user equipment. The apparatus may include a communication unit, a formation unit, an input unit, and a display unit.

The communication unit may be configured to retrieve content associated with at least one application of the user equipment. The formation unit may be configured to form at least one background screen of the user interface from at least one image. Each of the at least one background screen may be associated with a respective one of the at least one application, and each image of the at least one image may represent a respective content associated with the respective application. The input unit may be configured to receive an input from a user. The display unit may be configured to display the user interface having the at least one background screen formed from the at least one image.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 illustrates a telecommunication network coupled to a user equipment for providing a user interface having at least one live wallpaper, in accordance with embodiments;

FIG. 2 illustrates a user equipment for providing a user interface having at least one live wallpaper, in accordance with embodiments;

FIG. 3 illustrates a method for providing a user interface in a user equipment, in accordance with embodiments;

FIG. 4 illustrates a method for setting up a live wallpaper of a user interface in a user equipment, in accordance with embodiments;

FIG. 5 illustrates a method for providing a desired content selected from a displayed live wallpaper in a user equipment, in accordance with embodiments;

FIGS. 6A and 6B illustrate an example of setting up a live wallpaper of a user equipment, in accordance with embodiments;

FIGS. 7A and 7B illustrate another example of setting up a live wallpaper of a user interface, in accordance with embodiments;

FIG. 8 illustrates an example of providing a live wallpaper through a main menu invoked by a predetermined gesture input, in accordance with embodiments;

FIG. 9 illustrates an example of providing a live wallpaper through a main menu invoked by a predetermined key input, in accordance with embodiments;

FIG. 10 illustrates an example of popping up a selected image upon a receipt of a user input on a live wallpaper associated with a music player, in accordance with embodiments; and

FIG. 11 illustrates an example of popping up a selected image upon a receipt of a user input on a live wallpaper associated with Internet news, in accordance with embodiments.

### DETAILED DESCRIPTION OF THE INVENTION

Reference will now be made in detail to embodiments of the present invention, examples of which are illustrated in the accompanying drawings, wherein like reference numerals refer to like elements throughout. The embodiments are described below, in order to explain the present invention by referring to the figures.

In accordance with embodiments, a user equipment may form at least one background screen of a user interface from at least one image each representing respective content. Upon receiving a predetermined gesture input or a predetermined key input from a user, the user equipment may display a main menu which allows the user to select a desired application to be executed over a current display screen. When the user selects a desired application from the displayed main menu, the user equipment may display the user interface having the background screen formed from the at least one image corresponding to the selected desired application. The displayed user interface having the background screen may be updated at a certain interval of time by receiving updated content.

Such a background of a user interface may be referred to as an active background, a live background, an active wallpaper, and/or a live wallpaper. Hereinafter, for convenience and ease of understanding, the term “live wallpaper” will be used throughout the specification in order to describe any or all of the background, the active and/or live background, and the active and/or live wallpaper. In general, the live wallpaper may be a type of application that functions as a background image of a user interface and interacts with the user in response to a user action. For example, the live wallpaper may be configured of a plurality of icons or images each associated with a set of events. When a user selects one of the icons or images in the live wallpaper, the user equipment may perform a set of events associated with the selected icon or image.

In accordance with embodiments, a user equipment may form at least one live wallpaper with a plurality of images each representing content associated with a web based application. Such a user equipment may be coupled to a telecommunication network in order to obtain the content therefrom.

In accordance with embodiments, a user equipment may form at least one live wallpaper with a plurality of images each representing respective content stored in a memory. Such a user equipment may not necessarily need to be coupled to a telecommunication network in order to obtain the content therefrom. When a user selects one of the images from the live wallpaper, the user equipment may play or display a desired content corresponding to the selected image by running a corresponding application.

In accordance with embodiments, when a user equipment receives a predetermined gesture input or a predetermined key input while executing an application or displaying any of live wallpapers, the user equipment may display a main menu which allows a user to select a desired application to be executed over a current display screen. Upon receiving a user input for selecting a desired application, the user equipment may display a live wallpaper formed from a plurality of images corresponding to the selected desired application. Accordingly, a user may have a quick access to his/her favorite content associated with applications provided by a user equipment.

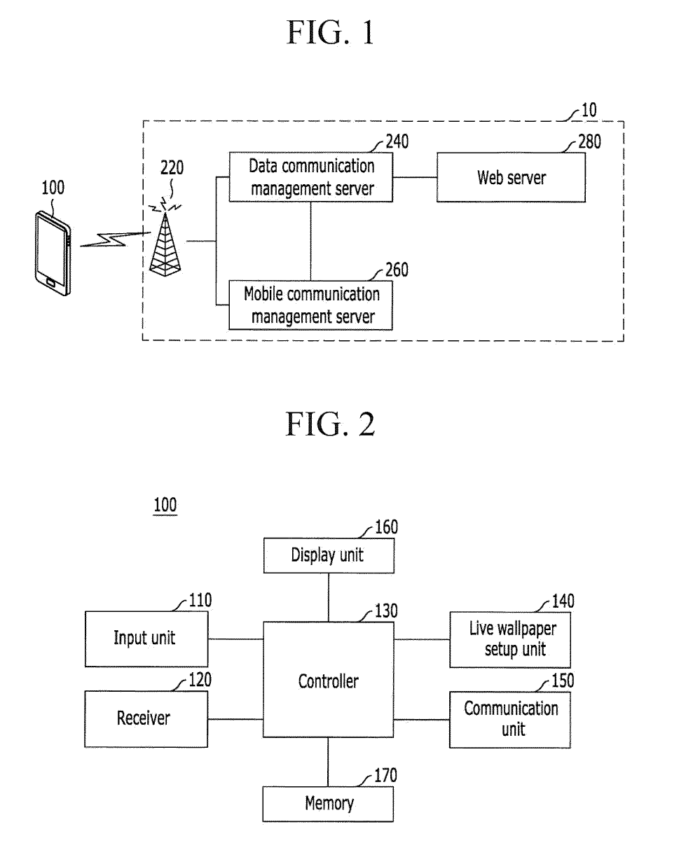

FIG. 1 illustrates a telecommunication network coupled to a user equipment for providing a user interface having at least one live wallpaper, in accordance with embodiments. User equipment 100 may be coupled to a telecommunication network 10. The telecommunication network 10 may include a base station 220, a data communication management server 240, a mobile communication management server 260, and a web server 280.

In accordance with embodiments, the user equipment 100 may form at least one live wallpaper with a plurality of images related to content received from the web server 280 in response to a user input and may display the live wallpaper as a background of a user interface. In order to communicate with the web server 280, the user equipment 100 may be coupled to the base station 220 of the telecommunication network 10 through a wireless link. Particularly, the user equipment 100 may communicate with other user equipments, terminals, or servers coupled to the telecommunication network 10 through the base station 220. Through the base station 220, the user equipment 100 may transmit the user input to the web server 280 and receive corresponding content from the web server 280.

The user equipment 100 may receive the user input from a user. The user input may be user interest information, but is not limited thereto. For example, the user input may be a search word or an information type that the user is interested about. The information type may be related to news, music, and/or movies. Alternatively, a user may select at least one information type from one or more displayed on the user equipment 100 or from search results provided from the web server 280 and input the selected information type to the user equipment 100.

After receiving the user input, the user equipment 100 may request corresponding content from the web server 280. In response to the request, the user equipment 100 may receive content from the web server 280. Each content may include images related to the user input and supplementary information thereof. The user equipment 100 may form a live wallpaper based on the content. Particularly, the user equipment 100 may set up a live wallpaper with an image or images included in the content.

Such a live wallpaper may be formed by arranging images included in content in a certain format. For example, the live wallpaper may be divided into at least one sub-screen and the images may be arranged in the sub-screens to form the live wallpaper. After forming the live wallpaper, the user equipment 100 may display the live wallpaper as a background of a user interface. When a user selects one of the images of the live wallpaper, the user equipment 100 may access a web server associated with the selected image and display a related web page received from the web server. Such a user equipment 100 for providing a user interface having live wallpaper in accordance with embodiments will be described later in more detail with reference to FIG. 2.

The user equipment 100 may be a device capable of communicating with others, accessing the Internet, and/or receiving various types of information from the Internet. For example, the user equipment 100 may be a wideband CDMA (WCDMA) phone, a smart phone, a personal digital assistant (PDA), a computer device, an MP3 player, a notebook computer, a net-book computer, and/or an e-book.

The base station 220 may be coupled to the user equipment 100 through a wireless link. The base station 220 may deliver data between the user equipment 100 and the web server 280. In order to deliver data between the user equipment 100 and the web server 280, the base station 220 may perform various operations, such as operations for processing a baseband signal, for transmitting and receiving a Radio Frequency (RF) signal, and for establishing a wireless link to the user equipment 100.

The data communication management server 240 may perform a role of a gateway that couples the user equipment 100 to the web server 280 through a communication network. The data communication management server 240 may perform operations for providing a wireless Internet service, such as transferring a request from the user equipment 100 to the web server 280 and transferring a corresponding Internet service to the user equipment 100. In order to provide the wireless Internet service, the data communication management server 240 may include a packet control function (PCF) and a packet data serving node (PDSN). The PDSN is a gateway for a wireless Internet service.

The data communication management server 240 may perform operations for matching different data types and different protocols between the user equipment 100 and the web server 280. The data communication management server 240 may receive a signal from the user equipment 100 in order to retrieve a web page corresponding to a selected image in the displayed live wallpaper. In order to retrieve the web page, the data communication management server 240 may access a corresponding web server, collect data for a related web page, and/or transmit the collected data to the user equipment 100.

The mobile communication management server 260 may include a mobile switching center (MSC) and a base station controller (BSC). The mobile communication management server 260 may detect a location of the user equipment 100 using a home location register (HLR) or a visitor location register (VLR).

The web server 280 may be coupled to the user equipment 100 through the data communication management server 240 and the base station 220. The web server 280 may provide content related to a user input to the user equipment 100. For example, the web server 280 may provide content to the user equipment 100 in response to a request for content related to a user input in order to set up a live wallpaper. The content may include images and supplementary information thereof. The supplementary information may be an access address of a web page associated with each image and a ranking of each web page. Such supplementary information may be mapped to corresponding images, and the mapping information may be stored in a memory. The access address may be a uniform resource locator (URL), and the ranking may be determined by various ways. The ranking may be decided based on a user preference, and/or based on search frequency of information related to each image, but is not limited thereto. Furthermore, the ranking may be decided by a web server based on information related to an associated web page or image. Embodiments, however, are not limited thereto.

FIG. 2 illustrates a user equipment for providing a user interface having at least one live wallpaper, in accordance with embodiments. The user equipment 100 may include an input unit 110, a receiver 120, a controller 130, a live wallpaper setup unit 140, a communication unit 150, a display unit 160, and a memory 170.

The input unit 110 may include a user interface (UI) for receiving a user input from a user. The user input may include a predetermined gesture input or a predetermined key input that generates a signal to invoke one or more functions of the user equipment. For example, the user input may be a control command or a function selection command for controlling general operations of the user equipment 100. The function selection command may be a command to invoke a live wallpaper setup function or a command for inputting a text input. Furthermore, the user input may include user interest information. For example, the user input may be a search word or an information type that a user is interested about in order to form a live wallpaper.

The input unit 110 may receive from a user at least one of the information types selected from those displayed on the display unit 160. The input unit 110 may include a keypad for inputting such information. The keypad may be displayed on the display unit 160 when the display unit 160 is a touch screen. For example, a user may type text using the keypad through the display unit 160 in order to input information.

The input unit 110 may receive a selection signal from a user to select an information displayed as the live wallpaper. For example, a user may use the input unit 110 to select an image of the live wallpaper. Furthermore, the input unit 110 may receive an update time from a user. In accordance with embodiments, the update time may be a time interval for updating information and/or images displayed as the live wallpaper.

The receiver 120 may receive content from the web server 280 in response to a user input of the user equipment 100. For example, the receiver 120 may receive a list of information types and content having images and supplementary information thereof from the web server 280 in response to a request of a user. The receiver 120 may receive such information at every update time and update the live wallpaper accordingly.

The controller 130 may perform operations for controlling constituent elements of the user equipment 100 including the input unit 110, the receiver 120, the display unit 160, the live wallpaper setup unit 140, the communication unit 150, and the memory 170. For example, the controller 130 may control the display unit 160 to display a main menu over a current display screen when receiving a predetermined gesture input or a predetermined key input. The controller 130 may control the display unit 160 to display a list of information types when the receiver 120 receives the list of information types from the web server 280. The controller 130 may control the display unit 160 to display one or more images each representing information as a live wallpaper as a user interface when the live wallpaper setup unit 140 forms the live wallpaper with images and supplementary information thereof included in the content from the web server 280. The controller 130 may extract an access address of a web page associated with an image selected by a user from the live wallpaper and control the communication unit 150 to access the web server 280 based on the extracted access address of a web page.

The live wallpaper setup unit 140 may set up at least one live wallpaper based on the content received from the web server 280 through the receiver 120. For example, the live wallpaper setup unit 140 may extract at least one image included in the content. The at least one image may represent information that a user is interested about. Then, the live wallpaper setup unit 140 may extract an access address and a ranking of a web page associated with the extracted image. The live wallpaper setup unit 140 may form a live wallpaper by mapping an access address of a web page to at least one image and arranging the at least one image in the live wallpaper according to a resolution of the display unit 160. The live wallpaper setup unit 140 may set sizes of images differently according to the ranking of each image. The live wallpaper setup unit 140 may update and set images of the live wallpaper again with updated content at a certain update interval of time.

The communication unit 150 may request the web server 280 to send content for setting up the live wallpaper. For example, the communication unit 150 may request content from the web server 280 at every update time. The communication unit 150 may retrieve a web page corresponding to an image selected by a user from the live wallpaper in response to a command given by the controller 130. The communication unit 150 may use an access address of the web page included in the supplementary data. The web page may be an electric document composed in a format of eXtensible Hyper linking Language (XHL), Hyper Text Markup Language (HTML), eXtensible Style sheet Language (XSL), and/or eXtensible Hypertext Markup Language (XHTML), but embodiment are not limited thereto. The web page may be in a format of a wireless application protocol (WAP), but embodiments are not limited thereto.

The display unit 160 may display information generated during operations of the user equipment 100 and/or display results of the operations. Furthermore, the display unit 160 may display numbers and/or texts that are input by a user through the input unit 110 in order to enable the user to confirm what has been inputted. For example, the display unit 160 may display a result of performing operations in each constituent element of the user equipment 100. The display unit 160 may display a main menu over a current display screen upon the reception of a predetermined gesture input or a predetermined key input. The display unit 160 may display a list of information types and images received from the web server 280 through the receiver 120. The display unit 160 may display a live wallpaper formed or set up by the live wallpaper setup unit 140. The display unit 160 may display a web page received from the web server 280 through the receiver 120. The display unit 160 may display information stored in the memory 170, such as images and videos. The display unit 160 may display an operation status of the user equipment 100, such as a battery status, a signal intensity, a date, and/or a current time. The display unit 160 may include a liquid crystal display (LCD), an organic light emitting display (OLED), an electrophoretic display (EPD), and/or other display types in accordance with embodiments.

The memory 170 may store applications, programs, data, and/or information used by constituent elements of the user equipment 100. The memory 170 may also store data generated by constituent elements of the user equipment 100. For example, the memory 170 may store a user input received from a user and a list of information types and content received from the web server 280 through the receiver 120. Furthermore, the memory 170 may store images, access addresses of web pages related to the images, rankings of web pages, and/or information on mapping between the images and the supplementary data thereof. The memory 170 may store a live wallpaper formed or set up by the live wallpaper setup unit 140.

The memory 170 may provide stored information and data to the controller 130, the display unit 160, the live wallpaper setup unit 140, and/or the communication unit 150 in response to requests therefrom. The memory 170 may include a plurality of sub-memories or be divided into a plurality of memories. For example, the memory 170 may be formed of a read only memory (ROM), a random access memory (RAM), and/or a flash memory.

In accordance with embodiments, a live wallpaper may be configured of a plurality of images each representing information that a user is interested in. That is, a live wallpaper, in accordance with embodiments, may display various pieces of information that a user is interested in. For example, when a live wallpaper is associated with a web based application, each image of the live wallpaper may be associated with an access address of a corresponding web page. When a user selects an image of the live wallpaper, a user equipment may provide detailed information related to the selected image, for example, by displaying a web page corresponding to the selected image.

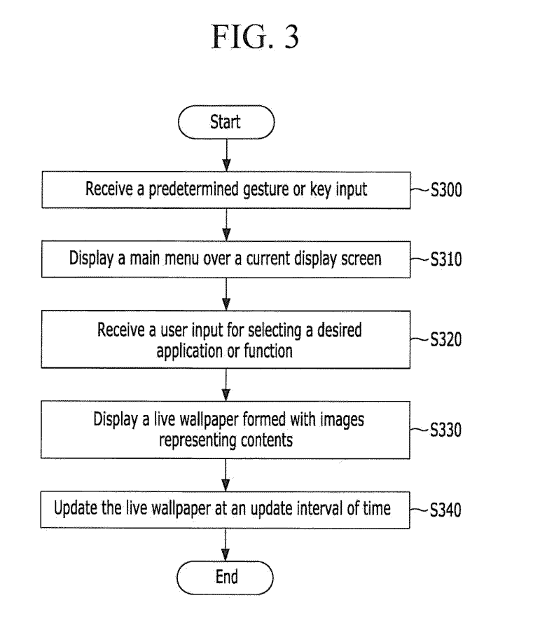

FIG. 3 illustrates a method for providing a user interface in a user equipment, in accordance with embodiments. A predetermined gesture input or a predetermined key input may be received S300. For example, the predetermined gesture input or key input may be inputted through an input unit 110. When a display unit 160 is a touch screen, the display unit 160 may also be the input unit 110. For example, the predetermined gesture input may be a pinching motion on the display unit 160 by using two fingers and the predetermined key input may be a menu key input displayed on the display unit 160 or disposed on a exterior of a user equipment 100. Then, a main menu which allows a user to select a desired application to be executed may be displayed over a current display screen S310. For example, a user equipment 100 may display the main menu on a display unit 160 and wait for a user input for selecting a desired application. The user input may be any action that generates a signal to invoke at least one function of the user equipment 100.

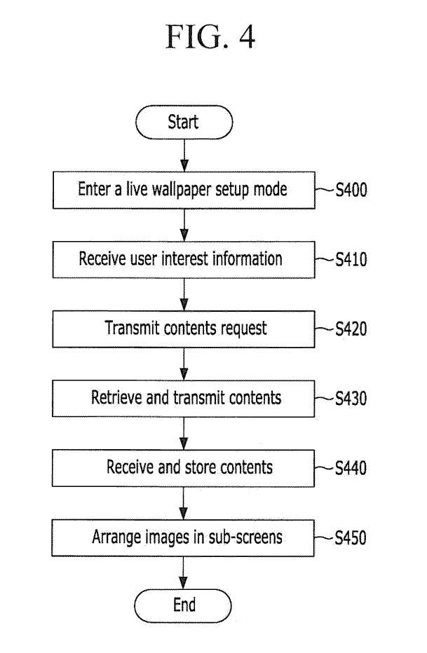

When a user input for selecting a desired application is received S320, a live wallpaper corresponding the selected desired application may be displayed S330. The live wallpaper may be formed from at least one image each representing content associated with the desired application. For example, the user equipment 100 may display the live wallpaper on the display unit 160. Such formation of the live wallpaper in accordance with embodiments will be described later in more detail with reference to FIG. 4.

In accordance with embodiments, the displayed live wallpaper may be updated at a predetermined update interval of time S340. For example, a communication unit 150 may request content to a web server 280 at every update time and a receiver 120 may receive updated content from the web server 280 and the live wallpaper may be updated with the updated content at the update interval of time accordingly.

FIG. 4 illustrates a method for setting up a live wallpaper of a user interface in a user equipment, in accordance with embodiments. Particularly, FIG. 4 illustrates a process of forming a live wallpaper associated with a web browser or a web based application, in accordance with embodiments. For example, the live wallpaper may be associated with Internet news which a user may be interested in.

Referring to FIG. 4, a live wallpaper setup mode may be entered upon a user input S400. For example, a user may select an icon displayed on the display unit 160 for setting up a live wallpaper. Then, user interest information may be received from a user S410. The live wallpaper may be configured of images each related to one or more user interests. In order to set up the live wallpaper, the user equipment 100 needs to obtain content related to the user interests from a corresponding web server 280. The content may include images and supplementary data. Accordingly, a user may input user interest information and the user equipment 100 may transmit the user interest information to the corresponding web server 280 to retrieve related content. The user interest information may be information that the user is interested about or information that the user wants to frequency update. For example, such user interest information may be a search word or an information type that a user is interested about. Furthermore, a user may select at least one information type from a list of information types displayed on the display unit 160 through the input unit 100. For example, the information type may be news, music, movies, books, shopping, restaurants, and/or travel. The user may input text into the user equipment 100 using a keypad displayed on the display unit 160.

After receiving the user interest information, a content request may be transmitted to a corresponding web server with the received user interest information S420. For example, the user equipment 100 may transmit a request to a corresponding web server for content related to the user interest information.

Content related to the user interest information may be retrieved from the web server and transmitted to the user equipment S430. For example, the web server 280 may search for content based on the user interest information. After retrieval of the content, the web server 280 may transmit the content to the user equipment 100. When a user selects news as user interest information, the web server may search for content related to news through the Internet.

As described above, the content may include images related to the user interest information and supplementary data thereof. In the case of news, the content may include images associated web pages related to news and supplementary data thereof. The supplementary data may include an access address of a web page associated with each image and a ranking of a web page associated with each image. The ranking may be determined by various ways based on a user setting. The ranking may be decided based on a user preference, based on the latest search, and/or based on search frequency of information related to each image. Furthermore, the ranking may be decided by a web server based on information related to an associated web page or image. Embodiments, however, are not limited thereto. For example, the ranking may be an Internet hit number of a web page associated with each image. An image associated with a web page having the largest Internet hit number may have the highest ranking. In the case of news as the user interest information, the ranking of each image may be decided based on popularity of an associated web page or based on an Intent hit number of an associated web page. Alternatively, the ranking of each image may be decided based on a user preference. When a user sets up an entertainment news as the first rank, a sports news as the second rank, and a society news as the third rank, an image related to the entertainment news may have the first ranking, an image related to the sports news may have the second ranking, and an image related to the society news may have the third ranking.

The content may be received and stored S440. For example, the user equipment 100 may receive the content from the web server 280. After receiving the content, the user equipment 100 may store the content in the memory 170.

A live wallpaper may then be formed with one or more images representing the received content S450. In accordance with embodiments, a live wallpaper setup unit 140 may divide the background screen of the live wallpaper into one or more sub-screens. Then, the live wallpaper setup unit 140 may extract at least one image related to the user interest information from the received content. For example, the live wallpaper setup unit 140 may select a certain number of images from the extracted images. The certain number of images to be selected may be referred to as a display number. The display number may be decided by a user or by an algorithm. That is, a user may input the display number through the input unit 110 of the user equipment 100.

After selecting the certain number of images, the live wallpaper setup unit 140 may extract supplementary data related to the selected certain number of images from the content. The supplementary data may include an access address of a web page associated with each image. The live wallpaper setup unit 140 may map each image to a corresponding access address of a web page associated with the corresponding image. Such mapping information may be stored in the memory 170.

The live wallpaper setup unit 140 may arrange the selected images in the sub-screens of the live wallpaper. The live wallpaper setup unit 140 may control the number of images to be arranged based on a resolution of the display unit 160. For example, the live wallpaper setup unit 140 may arrange more images when the display unit 160 supports a larger resolution. Furthermore, the live wallpaper setup unit 140 may control a size and/or a position of each image based on a ranking of each image. For example, the live wallpaper setup unit 140 may control a size of an image having the highest ranking to be larger than the other images. Furthermore, the live wallpaper setup unit 140 may control a position of an image having the highest ranking to be arranged at the center of the live wallpaper. However, embodiments are not limited thereto.

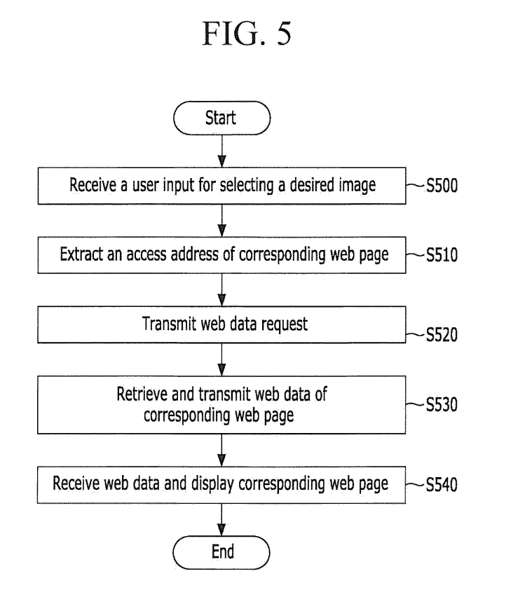

FIG. 5 illustrates a method for providing a desired content selected from a displayed live wallpaper in a user equipment, in accordance with embodiments. For example, the live wallpaper may be associated with a web browser or a web based application such as Internet news.

Referring to FIG. 5, while displaying a live wallpaper formed from one or more images, a user input for selecting an image from the displayed one or more images on the live wallpaper may be received S500, in accordance with embodiments. Then, an access address of a web page mapped to the selected image may be extracted S510. For example, the user equipment 100 may retrieve an access address of a corresponding web page from the memory 170 based on the stored mapping information, in accordance with embodiments.

A web data request may be transmitted to a corresponding web server based on the extracted access address S520. For example, the user equipment 100 may transmit a web data request to the web server 280 in order to open a web page related to the selected image. Then, web data for a corresponding web page may be retrieved and transmitted to the user equipment S530. For example, the web server 280 may retrieve web data for a corresponding web page in response to the web data request from the user equipment 100. After retrieving the web data, the web server 280 may transmit the web data to the user equipment 100. The web data may be received and the corresponding web page may be displayed S540. For example, the user equipment 100 may receive the web data from the web server 280 and display a corresponding web page based on the received web data, in accordance with embodiments.

As described above, the live wallpaper may be formed with images related to user interests. A user may quickly and conveniently receive updated information through the live wallpaper. Hereinafter, examples of setting up and using the user interface having the live wallpaper in accordance with embodiments will be described in more detail.

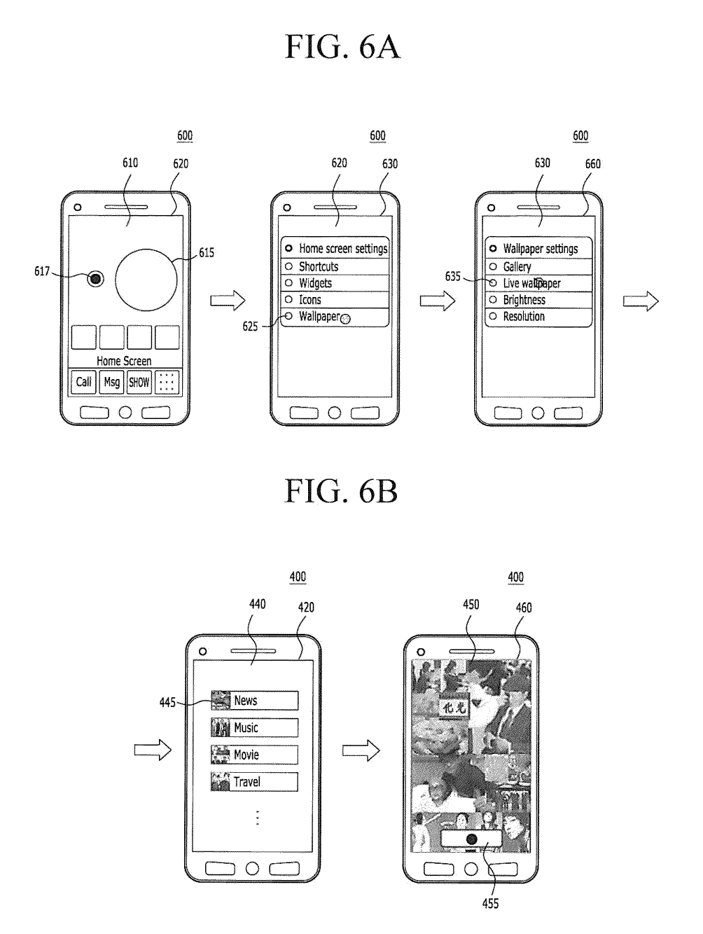

FIGS. 6A and 6B illustrate an example of setting up a live wallpaper of a user equipment, in accordance with embodiments. For example, the live wallpaper may be associated with a web browser or a web based application such as Internet news, in accordance with embodiments.

Referring to FIG. 6A, a user equipment 600 may display a home screen 610 on a display unit 660 before setting up a live wallpaper, in accordance with embodiments. The home screen 610 may be a default graphical user interface (GUI) that a user may interact with in order to enter inputs and/or requests. The GUI may output information in response to various user requests. Before setting up the live wallpaper, the home screen 610 may include a wallpaper such as a background image and a plurality of icons and menu keys displayed on the wallpaper. The plurality of icons may include a home screen setting icon 615 for invoking a home screen setting function.

When a user selects the home screen setting icon 615, the user equipment 600 may carry out a home screen setting function. Using the home screen setting function, a user may set up the home screen including setting up a live wallpaper in accordance with embodiments as well as adding icons, shorts, and widgets and/or changing properties of the home screen. Alternatively, the home screen setting function may be invoked when a user selects any unblocked area 617 of the wallpaper. The unblocked area 617 may be an area that is not blocked by icons or menu keys in the home screen. When a user selects the unblocked area 617 of the typical wallpaper, the user equipment 600 may display menu keys for performing a home screen setting function.

When the home screen setting function is invoked in response to a user input as described above, the user equipment 600 may display a home screen setting interface 620. The home screen setting interface 620 may include, a plurality of options including a wallpaper setting option 625. The home screen setting interface 620 may further include an option for adding shortcuts, an option for adding widgets, and an option for changing properties such as a font size or an icon size.

When a user selects the wallpaper setting option 625, the user equipment 600 may display a wallpaper setting interface 630. The wallpaper setting interface 630 may include a live wallpaper setting and activating option 635. The live wallpaper setting and activation option 635 may be associated with a live wallpaper setting and activating function.

When a user selects the live wallpaper setting and activating option 635, an information selection interface 640 may be displayed on the display unit 660. The information selection interface 640 may include various information types, such as news, music, movie, and travel.

When a user selects one of the information types, the user equipment 600 may collect content based on the selected information type from corresponding web servers and form a live wallpaper based on the collected content.

After forming the live wallpaper, the user equipment 600 may display the live wallpaper 650 as a preview. If a user likes the live wallpaper 650, a user may activate a confirmation key 655. In response to the activation of the confirmation key, the user equipment 600 may display the live wallpaper 650 on the display unit 660.

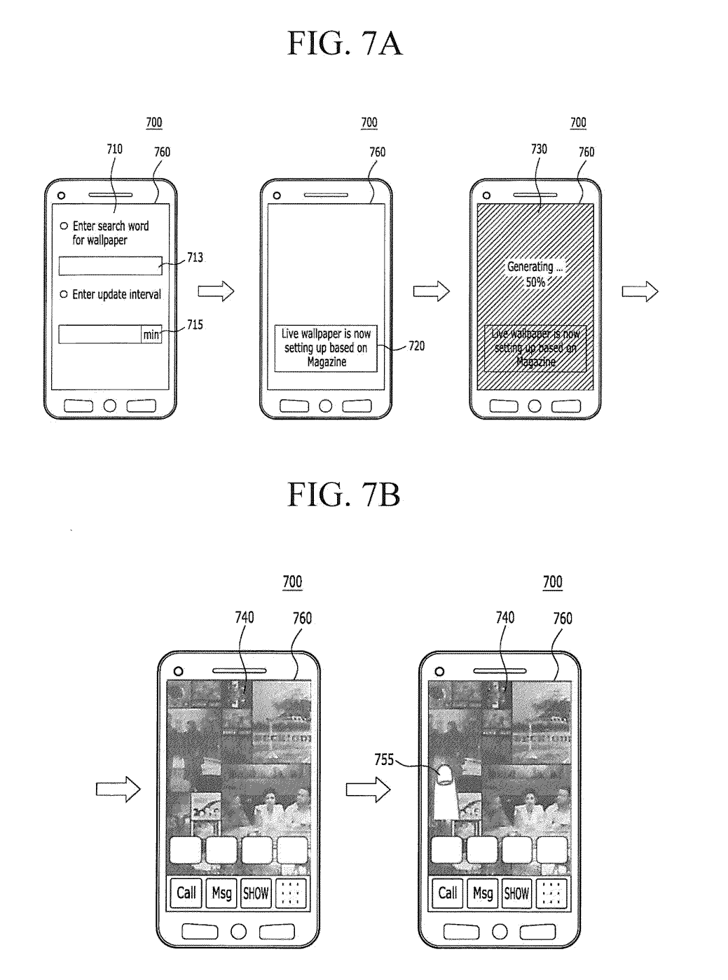

FIGS. 7A and 7B illustrate another example of setting up a live wallpaper of a user interface, in accordance with embodiments. For example, the live wallpaper may be associated with a web browser or a web based application such as a keyword search engine.

Referring to FIG. 7A, a user equipment 700 may display a live wallpaper setting interface 710 on a display unit 760, in accordance with embodiments. Such a live wallpaper setting interface 710 may be displayed after the user selects the live wallpaper setting and activating option 735 from the wallpaper setting interface 730 as shown in FIG. 6A, in accordance with embodiments. The live wallpaper setting interface 710 may include input windows to receive inputs from a user. A user may input user interest information and/or options for a live wallpaper through the input windows. For example, the live wallpaper setting interface 710 may include a search word input window 713 and an update time setting window 715. The user may input a word “magazine” into the search word input window 713 and input a time of “10 minutes” into the update time setting window 715. The user equipment 700 may update images of the live wallpaper at an interval of the update time set up by the user, for example, 10 minutes.

After inputting the user interest information and/or options for the live wallpaper, the user equipment 700 may display a message 720 on the display unit 760 in order to inform the user that the live wallpaper is being configured with images related to the input user interest information from the user. Then, the user equipment 700 may display a status 730 of forming the live wallpaper.

After completing the configuration of the live wallpaper, the user equipment 700 may display the live wallpaper 740 with icons and keys on the display unit 760 of the user equipment 700. A user may select one image of the live wallpaper 740 using their finger 755. In this case, the user equipment 700 may access a web server based on an access address associated with the selected image and display a web page received from the web server.

In accordance with embodiments, a user equipment may provide at least one live wallpaper of a user interface which is formed from one or more images associated with content stored in a memory. Such a user equipment may divide a background screen of the live wallpaper into a plurality of sub-screens based on the number of the stored content, extract at least one image included in the content, and arrange the extracted at least one image into the sub-screens. Each sizes of the sub-screens may be set up differently according to a user preference. The size of each of the extracted images may be equal to or different from the size of each of the sub-screens to be disposed on. If the size of a sub-screen is equal to the size of an extracted image, then the extracted image may be arranged on the sub-screen without changing its size. On the other hand, if the size of a sub-screen is different from the size of an extracted image, then the extracted image may be disposed on the sub-screen at an adjusted size to correspond to the size of the sub-screen.

As described above, in accordance with embodiments, at least one live wallpaper of a user interface may be formed with at least one images each representing a respective content associated an application or a function provided by a user equipment. Such a user equipment may provide a main menu which allows a user to select a desired application or function anytime the user wants. The main menu may be invoked by receiving a predetermined gesture input or a predetermined key input while executing an application or displaying any of live wallpapers. For example, the predetermined gesture input may be a pinching motion on the display unit by using two fingers and the predetermined key input may be a menu key input displayed on the display unit or disposed on a exterior of a user equipment.

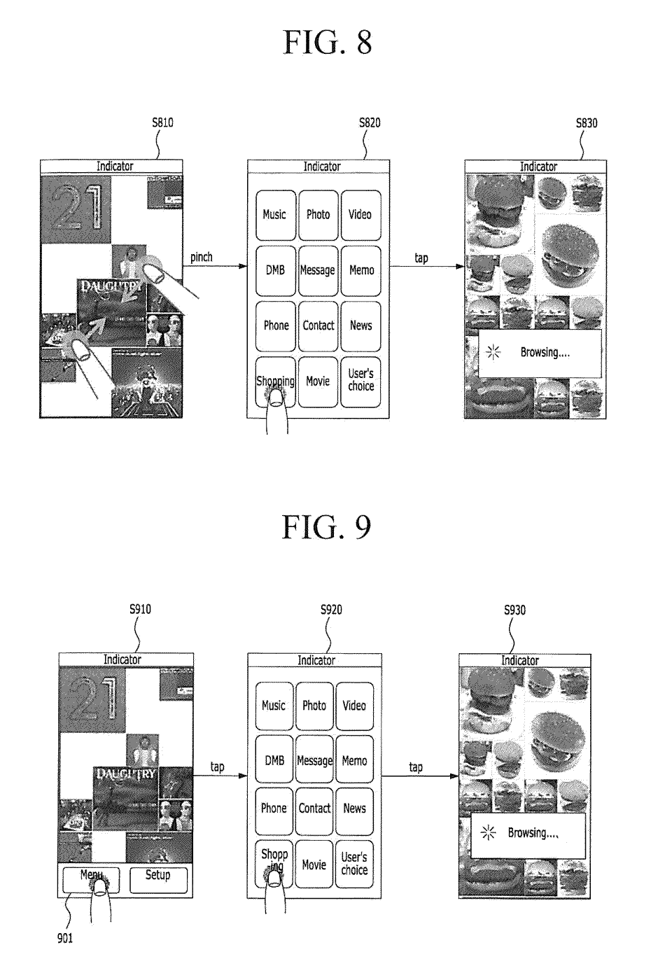

FIG. 8 illustrates an example of providing a live wallpaper through a main menu invoked by a predetermined gesture input, in accordance with embodiments. A predetermined gesture input may be received S810. For example, a pinching motion using two fingers may be performed on a display unit. Then, a main menu including a plurality of icons or images each corresponding to a respective application or functions of a user equipment may be displayed on a current display screen S820. For example, the main menu may include a plurality of icons or images representing applications or functions of a user equipment such as music, photo, video, DMB, message, memo, phone, contact, news, shopping, movie, etc. When a user selects an icon or image representing a desired application, the user equipment may display a corresponding live wallpaper formed with at least one image associated with the selected desired application S830.

FIG. 9 illustrates an example of providing a live wallpaper through a main menu invoked by a predetermined key input, in accordance with embodiments. A predetermined key input may be received S910. For example, a menu key displayed on a display unit may be predetermined as a key input for invoking a main menu. Then, a main menu including a plurality of icons or images each corresponding to a respective application or functions of a user equipment may be displayed on a current display screen S920. For example, the main menu may include a plurality of icons or images representing applications or functions of a user equipment such as music, photo, video, DMB, message, memo, phone, contact, news, shopping, movie, etc. When a user selects an icon or image representing a desired application, the user equipment may display a corresponding live wallpaper formed with at least one image associated with the selected desired application S930. Accordingly, a user may have a quick access to his/her favorite content associated with applications provided by a user equipment.

In accordance with embodiments, when a user equipment receives a selection of a desired image from a displayed live wallpaper, the user equipment may enlarge the selected image to a certain size and the enlarged image may be popped up for a certain time period.

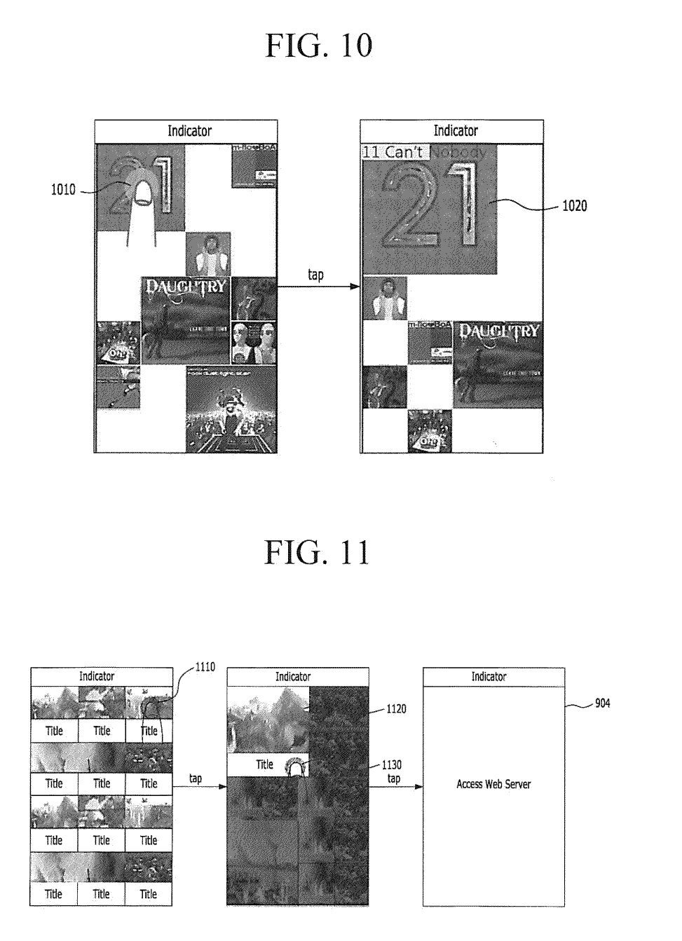

FIG. 10 illustrates an example of popping up a selected image upon a receipt of a user input on a live wallpaper associated with a music player, in accordance with embodiments. As shown in FIG. 10, a user input 1010 may be received on an image representing a desired music which a user wants to listen to, in accordance with embodiments. The selected image 1020 may be enlarged to a certain size and popped up for a certain time period.

FIG. 11 illustrates an example of popping up a selected image upon a receipt of a user input on a live wallpaper associated with Internet news, in accordance with embodiments. As shown in FIG. 11, a user input 1110 may be received on an image representing a desired news which a user wants to read. The selected image 1120 may be enlarged to a certain size and popped up for a certain time period. After receiving another user input 1130 on the popped up image, a user equipment may connect a web server in order to receive a corresponding content associated with the selected image 1140.

As described above, in accordance with embodiments, a user may have relatively quick access to his/her favorite content associated with an application even while another application is running. In accordance with embodiments, when a user selects a desired image displayed on a live wallpaper, a user equipment may provide a desired content corresponding to the selected image by executing a corresponding application to provide the desired media content. Accordingly, the user can conveniently and quickly enjoy his/her favorite content.

In accordance with embodiments, the methods for setting up and providing a media wall as a user interface for media content may be realized as a program and stored in a computer-readable recording medium such as a CD-ROM, a RAM, a ROM, floppy disks, hard disks, magneto-optical disks, and the like. Such can be easily implemented by those skilled in the art to which embodiments pertain.

The terms used in the present application are merely used to describe particular embodiments, and are not intended to limit the present invention. An expression used in the singular encompasses the expression of the plural, unless it has a clearly different meaning in the context. In the present application, it is to be understood that the terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for providing a user interface in a user equipment, the method comprising;
forming at least one background screen of the user interface from at least one image, wherein each of the at least one background screen is associated with a respective one of applications of the user equipment and each image of the at least one image represents a respective content associated with the respective application;
receiving at least one input selected from a predetermined gesture input and a predetermined key input from a user;
displaying a main menu which allows the user to select a desired application to be executed over a current display screen;
receiving a selection input for selecting the desired application from the displayed main menu; and
displaying the user interface having the background screen formed from the at least one image corresponding to the selected desired application.

2. The method of claim 1, wherein after the displaying the user interface having the background screen, the method further comprises:
receiving updated content associated with a respective application; and
updating the displayed user interface having the background screen with the received updated content at an update interval of time.

3. The method of claim 1, wherein the forming the at least one background screen of the user interface comprises:
receiving information from the user;
retrieving content based on the received information;
dividing the background screen of the user interface into at least one sub-screen;
extracting the at least one image from the retrieved content;
extracting supplementary data associated with the extracted at least one image from the retrieved content;
mapping the extracted at least one image with corresponding supplementary data;
storing a result of the mapping; and
arranging the extracted at least one image in the at least one sub-screen to form the background screen of the user interface.

4. The method of claim 3 wherein the arranging the extracted at least one image comprises:
controlling at least one of a size and a position of each image of the extracted at least one image according to a ranking associated with each image.

5. The method of claim 3, wherein the information received from the user comprises at least one of a search word and an information type that the user is interested about.

6. The method of claim 5, wherein:
the content comprises at least one image related to the information received from the user and supplementary data associated with each image of the at least one image, and the supplementary data comprises an access address and a ranking of a web page related to each image of the at least one image; and
each image of the at least one image represents a respective type of the information received from the user.

7. The method of claim 6, wherein the ranking of each web page is determined based on at least one of a user stipulation, an associated web server, a search frequency of related information type, and an Internet hit count of the corresponding web page.

8. The method of claim 3, wherein after the receiving the information from the user, the method further comprises:
transmitting a request to a web server to search for content related to the information received from the user,
wherein the web server searches for the related content and provides the related content.

9. The method of claim 3, wherein after the displaying the user interface having the background screen, the method further comprises:
selecting a desired image from the background screen formed from the at least one image;
extracting an access address of a web page corresponding to the selected desired image based on the stored result of the mapping;
retrieving data for the corresponding web page using the extracted access address; and
displaying the corresponding web page based on the retrieved data.

10. The method of claim 1, wherein the forming the at least one background screen of the user interface comprises:
retrieving content associated with an application from a memory of the user equipment;
dividing the background screen of the user interface into at least one sub-screen;
extracting the at least one image;
arranging the extracted at least one image in the at least one sub-screen to form the background screen;
mapping the arranged at least one image with corresponding content; and
storing a result of the mapping.

11. The method of claim 10, wherein the dividing the background screen into the at least one sub-screen comprises:
dividing the background screen into a number of sub-screens corresponding to the number of items in the retrieved content.

12. The method of claim 10, wherein the arranging the extracted at least one image in the at least one sub-screen comprises:
controlling at least one of a size and a position of each image of the extracted at least one image according to a user preference associated with each content.

13. The method of claim 10, wherein after the displaying the user interface having the background screen, the method further comprises:
receiving a selection input for selecting a desired image from the background screen;
extracting, based on the stored result of the mapping, content information corresponding to the selected desired image; and
playing a desired content by executing an application corresponding to the extracted content information.

14. The method of claim 1, wherein the forming the at least one background screen of the user interface comprises:
dividing each of the at least one background screen into at least one sub-screen such that each one of the at least one sub-screen has a same size.

15. The method of claim 1, wherein the forming the at least one background screen of the user interface comprises:
dividing each of the at least one background screen into at least one sub-screen such that ones of the at least one sub-screen have varying sizes.

16. An apparatus for providing a user interface in a user equipment, the apparatus comprising;
a communication unit configured to retrieve content associated with at least one application of the user equipment;
a formation unit configured to form at least one background screen of the user interface from at least one image, wherein each of the at least one background screen is associated with a respective one of the at least one application, and each image of the at least one image represents a respective content associated with the respective application;
an input unit configured to receive an input from a user; and
a display unit configured to display the user interface having the at least one background screen formed from the at least one image.

17. The apparatus of claim 16, wherein the display unit is further configured to display a main menu which allows the user to select a desired application to be executed over a current display screen when receiving at least one of a predetermined gesture input and a predetermined key input from the user.

18. The apparatus of claim 16, wherein the communication unit is further configured to receive updated content so that the displayed user interface having the background screen is updated in accordance with the received updated content at an update interval of time.

19. The apparatus of claim 16, wherein the formation unit is further configured to divide the background screen of the user interface into at least one sub-screen based on the number of items of the retrieved content, and configured to arrange the at least one image in the at least one sub-screen by controlling a size of each image of the at least one image in accordance with a size of a respective sub-screen in which the image is placed.

20. A computer program product embodied on a computer-readable storage medium, which when executed by a computer of a user equipment, the computer program product causes the computer to perform a method, the method comprising:
forming at least one background screen of the user interface from at least one image, wherein each of the at least one background screen is associated with a respective one of applications of the user equipment, and each image of the at least one image represents a respective content associated with the respective application;
receiving at least one input selected from a predetermined gesture input and a predetermined key input from a user;
displaying a main menu which allows the user to select a desired application to be executed over a current display screen;
receiving a selection input for selecting the desired application from the displayed main menu; and
displaying the user interface having the background screen formed from the at least one image corresponding to the selected desired application.
